(19) United States
(12) Patent Application Publication
(10) Pub. No.: US 2015/0367860 A1
(43) Pub. Date: Dec. 24, 2015

(54) method and device for assisting the driver of a two-wheeled vehicle in approaching curves

(71) Applicant: ROBERT BOSCH GMBH, Stuttgart (DE)

(72) Inventors: Markus Koehler, Freiberg (DE); Anja Wahl, Markgroeningen (DE)

(21) Appl. No.: 14/655,202

(22) PCT Filed: Nov. 21, 2013
(86) PCT No.: PCT/EP2013/074349

§ 371 Date: Jun. 24, 2015

(30) Foreign Application Priority Data
Jan. 14, 2013 (DE) 102013200435.4

(51) Int. Cl. B60W 50/14

(52) U.S. Cl. CPC B60W 50/14; B60W 2550/143; B60W 2550/146

(57) ABSTRACT

A method and a device for assisting the driver of a two-wheeled vehicle in approaching curves, in which the topology of a curve lying ahead of the two-wheeled vehicle in the driving direction is ascertained with the aid of a navigation system, a suitable travel trajectory for safe cornering is ascertained, the position of the two-wheeled vehicle inside the own traffic lane is determined, and an information arrangement informs the driver about the direction in which to steer the two-wheeled vehicle in order to reach the ascertained driving trajectory.

### FIELD OF THE INVENTION

The present invention relates to a method and device for assisting the driver of a two-wheeled vehicle in approaching curves.

### BACKGROUND INFORMATION

The use of cameras, especially mono video cameras, for driver-assistance systems for passenger cars is already believed to be understood. Road markings, and thus the traffic lane, are able to be detected in a reliable manner with the aid of these systems. If the camera systems are further configured so that asphalt boundaries are detected as well, then the traffic lane is known even without markings. The use of camera systems in motorized two-wheeled vehicles is not yet common so far.

Navigation systems with stored maps, which include the upcoming road course, are part of the related art as well. By glancing at the navigation system, many drivers of two-wheeled vehicles check to determine the characteristic of the upcoming curve and the manner in which it is to be approached.

### SUMMARY OF THE INVENTION

The present invention relates to a method for assisting the driver of a two-wheeled vehicle in approaching curves, in which
At least one topological characteristic of a curve lying ahead of the two-wheeled vehicle in the direction of travel is ascertained with the aid of a navigation system;
the position of the two-wheeled vehicle inside the own traffic lane is determined; and
depending on the topological characteristic of the curve and the position of the two-wheeled vehicle, an information arrangement advises the driver of the direction in which to steer the two-wheeled vehicle in order to enter the ascertained driving trajectory.

This makes it easier for the driver to travel through curves.

One advantageous development of the present invention is characterized in that
a driving trajectory suitable for safe cornering is ascertained as a function of the at least one topological characteristic;
depending on the ascertained driving trajectory and the position of the two-wheeled vehicle, an information arrangement informs the driver of the direction in which to steer the two-wheeled vehicle in order to enter the ascertained driving trajectory.

One advantageous development of the present invention is characterized in that the tightest radius of curvature of the curve lying in front of the two-wheeled vehicle is ascertained as the topological characteristic. The radius of curvature of the curve is the most essential topological quantity, based on which a safe driving trajectory is able to be determined.

One advantageous development of the present invention is characterized in that the position of the two-wheeled vehicle in the transverse road direction is ascertained, the transverse position associated with the ascertained driving trajectory is determined, and the information arrangement is actuated as a function thereof.

One advantageous development of the present invention is characterized in that the information arrangement includes an arrow symbol pointing to the right and an arrow symbol pointing to the left.

One alternative advantageous development of the present invention is characterized in that the information arrangement is a head set, through which the driver is instructed by voice output to adapt or modify the transverse position inside the traffic lane.

The two developments described last are especially suitable for supplying the driver with the transverse position inside the traffic lane that allows it to drive safely through the curve.

One advantageous development of the present invention is characterized in that the driver is additionally informed whether the two-wheeled vehicle should be decelerated, allowed to roll or should be accelerated. This constitutes meaningful supplementary information for safely driving through a curve.

One advantageous development of the present invention is characterized in that the driver is notified when a predefined distance from the beginning of the curve has been reached.

One advantageous development of the present invention is characterized in that the speed of the two-wheeled vehicle is taken into account when the suitable driving trajectory is ascertained. This makes it possible to take into account that earlier braking of the two-wheeled vehicle is required with increasing speed.

One advantageous development of the present invention is characterized in that the two-wheeled vehicle is a motorcycle.

In addition, the present invention encompasses a device, which includes an arrangement configured to implement the method of the present invention. More specifically, this device is a control unit equipped with the program code for executing the method according to the present invention.

### BRIEF DESCRIPTION OF THE DRAWINGS

FIG. 1 shows an optimal driving trajectory for two-wheeled vehicles.

FIG. 2 shows an unsuitable approach of a left-hand curve by a motor cycle. The curve is approached too closely from the inside.

FIG. 3 shows the sequence of one specific embodiment of the method of the present invention in the form of a flow chart.

### DETAILED DESCRIPTION

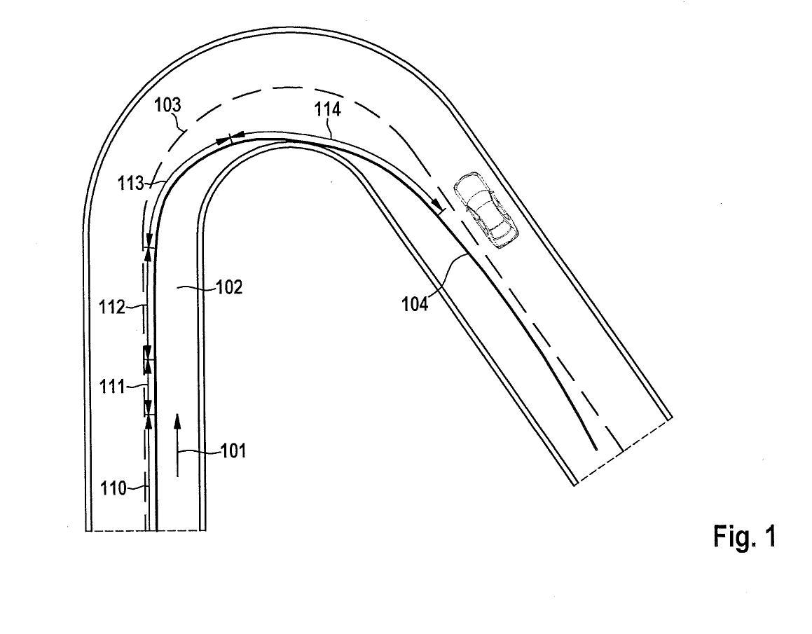

In contrast to passenger cars and due to the low lateral extension of motorized two-wheeled vehicles, the road width offers drivers of two-wheeled vehicles the opportunity to select their actual driving trajectory in a form that is adapted for cornering within the traffic lane and thus in an optimal manner for motorcycle riding. FIG. 1 illustrates such an optimal driving trajectory. There, arrow 101 identifies a motorcycle moving in the direction of the arrow and entering a right-hand curve. 102 identifies the right traffic lane, in which the motorcycle is situated, 103 denotes the center line that delimits the right traffic lane from the oncoming lane. Solid line 104 indicates the optimal driving trajectory for the motorcycle. At the same time, reference numerals 110-113 in FIG. 1 indicate the driving states “braking”, “rolling” and “accelerating” that are optimal for cornering. Starting with a motorcycle that is still accelerating in region 110, the driving state in region 111 transitions to rolling, and then to braking in region 112. In region 113, which represents the beginning of the curve, the motorcycle is rolling again, and in region 114, an acceleration of the motorcycle is meaningful.

The cornering assistant for motorized two-wheeled vehicles is meant to assist the driver in approaching a curve correctly. The data from a navigation system provides information about the distance that remains between the motor vehicle and the curve. A camera system installed in the motorcycle ascertains the position of the motorcycle inside the own traffic lane. This makes it possible to determine whether the position of the motorcycle inside the traffic lane is suitable for optimal cornering. In an excessive deviation between the position and the position of optimal cornering, which is usually at the outside of the curve, the motorcycle driver will be asked early enough before reaching the curve to steer the motorcycle onto the suitable trajectory. This may be accomplished by displaying a left or right arrow in the cockpit, for instance, or via a corresponding announcement in a headset. The present invention assists drivers of two-wheeled vehicles in entering curves along the outside, since entering curves from the center of the road frequently entails the risk that the two-wheeled vehicle will move into the oncoming traffic lane when exiting a curve.

To realize the present invention, the motorcycle needs to be equipped with a camera system and a navigation system. The camera system makes it possible to detect the traffic lane and the position of the vehicle inside the own traffic lane. Passenger cars already use the lane detection for assistance systems. For motorized two-wheeled vehicles, the detection of the roadway markings should be expanded to ensure that the roll angles, which are relatively large in comparison with passenger vehicles, are taken into account in the image processing algorithm for the lane detection.

If no road markings are present, then the entire road width can be recorded with the aid of the camera based on the asphalt boundaries and in turn be used for calculating the own driving trajectory. The upcoming curve characteristic is known via a navigation system and, in particular, the narrowest radius of curvature r as well.

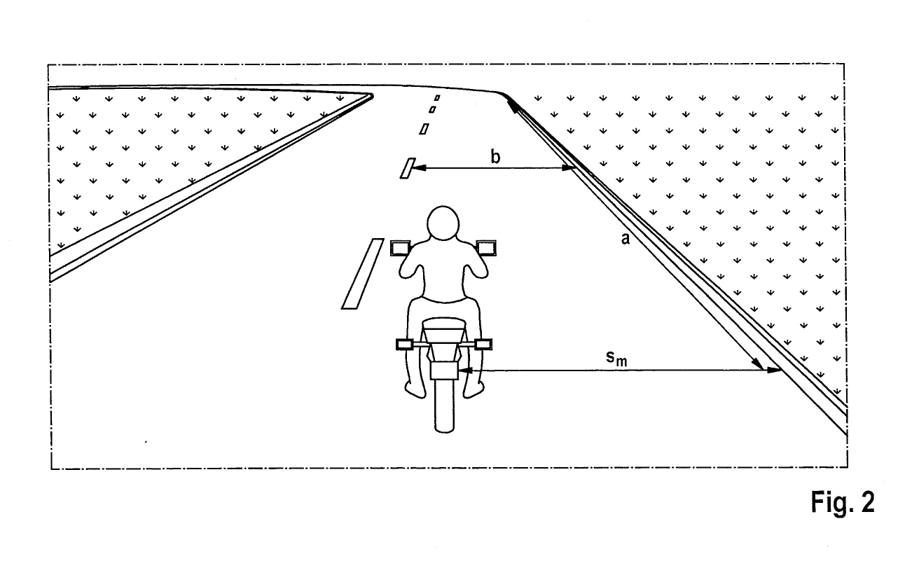

FIG. 2 shows a motorcycle which is entering a left-hand curve. Depending on the own traffic lane width b, distance a to the beginning of the curve, current vehicle speed v, and the upcoming curve characteristic with the narrowest arising radius of curvature r, i.e., the greatest curvature of the bend, an optimal driving trajectory and thus an optimal curve starting position s0 is calculated in the cornering assistant. If the distance between position sm of the motorcycle inside the own traffic lane and the optimal curve starting position s0 exceeds a predefined threshold, then the driver will be advised in a suitable manner, e.g., via arrows in the cockpit or via an acoustic announcement in the headset, to correct his or her position within the traffic lane.

In a further development stage, it is conceivable to assist the driver not only in approaching a curve, but also to indicate to the driver the optimal driving trajectory with the regions of braking, rolling, and accelerating in the display of the navigation system. Ideally, this expanded cornering assistant is combined with a curve warning device.

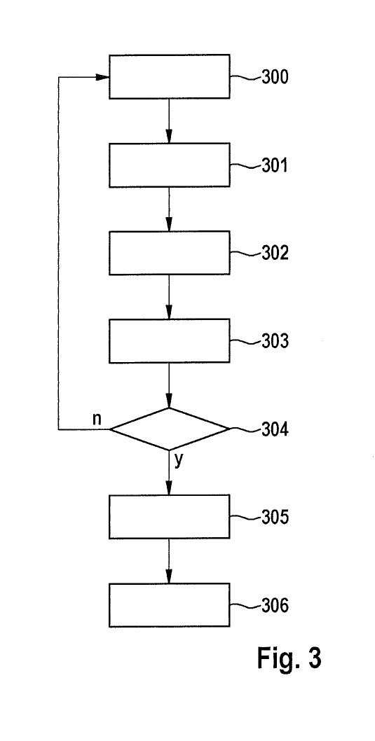

FIG. 3 shows a further development of the method according to the present invention in the form of a flow chart.

After the start of the method in block 300, at least one topological characteristic, such as the minimum radius of curvature, of a curve lying ahead of the two-wheeled vehicle in the direction of travel is ascertained in block 301. In block 302, a safe driving trajectory for cornering is determined. In block 303, the position of the two-wheeled vehicle inside its traffic lane is ascertained. This may be a transverse coordinate, in particular, i.e., a coordinate that characterizes the position of the two-wheeled vehicle in the transverse road direction. In block 304 it will then be queried whether the difference between the transverse coordinate of the two-wheeled vehicle and the corresponding transverse coordinate of the safe driving trajectory exceeds a threshold value. If this is not the case, i.e., if the two-wheeled vehicle is essentially situated along the optimal travel trajectory, then a return to block 300 takes place.

However, if the difference exceeds the threshold value, then the driver will be informed in block 305 about the suitable transverse position inside the traffic lane and possibly also of the steering direction, so that the vehicle reaches the optimal trajectory or the suitable transverse position. The method of the present invention ends in block 306.

1-11. (canceled)

12. A method for assisting a driver of a two-wheeled vehicle in approaching a curve, the method comprising:
ascertaining at least one topological characteristic of a curve situated in front of the two-wheeled vehicle in the driving direction with the aid of a navigation system;
ascertaining the position of the two-wheeled vehicle inside the own traffic lane is ascertained; and
informing, via an information arrangement, the driver as a function of the topological characteristic of the curve and the position of the two-wheeled vehicle, in which direction to steer the vehicle to reach the ascertained driving trajectory.

13. The method of claim 12, wherein a driving trajectory that is suitable for safe cornering is ascertained as a function of the at least one topological characteristic, and wherein an information arrangement informs the driver about the direction in which to steer the two-wheeled vehicle in order to reach the ascertained travel trajectory, as a function of the ascertained travel trajectory and the position of the two-wheeled vehicle.

14. The method of claim 12, wherein the narrowest radius of curvature of the curve situated ahead of the two-wheeled vehicle is ascertained as topological characteristic.

15. The method of claim 12, wherein the position of the two-wheeled vehicle in the transverse road direction is ascertained, wherein the transverse position associated with the determined travel trajectory is ascertained, and wherein the information arrangement is actuated as a function thereof.

16. The method of claim 12, wherein the information arrangement includes an arrow symbol pointing to the right and an arrow symbol pointing to the left.

17. The method of claim 12, wherein the information arrangement is a headset, via which the driver is orally instructed to modify the transverse position inside the traffic lane in the indicated direction.

18. The method of claim 12, wherein the driver is additionally informed whether to brake the two-wheeled vehicle, to allow it to roll, or to accelerate it.

19. The method of claim 12, wherein the information is given to the driver once a predefined distance to the beginning of the curve has been reached.

20. The method of claim 12, wherein the speed of the two-wheeled vehicle is taken into account when determining the suitable driving trajectory.

21. The method of claim 12, wherein the two-wheeled vehicle is a motorcycle.

22. A device for assisting a driver of a two-wheeled vehicle in approaching a curve, comprising:
an ascertaining arrangement to ascertain at least one topological characteristic of a curve situated in front of the two-wheeled vehicle in the driving direction with the aid of a navigation system, and to ascertain the position of the two-wheeled vehicle inside the own traffic lane is ascertained; and
an informing arrangement to inform, via an information arrangement, the driver as a function of the topological characteristic of the curve and the position of the two-wheeled vehicle, in which direction to steer the vehicle to reach the ascertained driving trajectory.
